(19) United States
(12) Patent Application Publication
(10) Pub. No.: US 2016/0119776 A1
(43) Pub. Date: Apr. 28, 2016

(54) SUBSCRIBER GROUP RELATED CONTROL IN A COMMUNICATION NETWORK

(71) Applicant: NOKIA SOLUTIONS AND NETWORKS OY, Espoo (FI)

(72) Inventor: Juha Antero RASANEN, Espoo (FI)

(21) Appl. No.: 14/890,466

(22) PCT Filed: May 13, 2013
(86) PCT No.: PCT/EP2013/059809

§ 371 Date: Nov. 11, 2015

(51) Int. Cl. H04W 8/18

(52) U.S. Cl. CPC H04W 8/186

(57) ABSTRACT

An apparatus of a communication network is provided, which detects (S10) that a user equipment attaching to the communication network belongs to a subscriber group, and determines (S11) a monitoring entity to monitor network resource usage for the user equipment and/or a control entity to control the monitoring for the user equipment, wherein for each user equipment belonging to the subscriber group the same monitoring entity and the same control entity are determined.

### BACKGROUND OF THE INVENTION

1. Field of the Invention

The present invention relates to subscriber group related control in a communication network. For example, the invention may be usable in usage monitoring control and user group applications.

2. Related Background Art

The following meanings for the abbreviations used in this specification apply:

3GPP 3^{rd} generation partnership project
DRA Diameter routing agent
E-UTRAN Evolved universal terrestrial radio access network
GCSE Group communication system enablers

### GW Gateway

HSS Home subscriber server

### ID Identity, Identifier

IP Internet protocol
LTE Long term evolution
PCC Policy and charging control
PCEF Policy and charging enforcement function
PCRF Policy and charging rules function
P-GW Packet data network gateway
QoS Quality of service
SPR Subscription profile repository
TR Technical report
UDR User data repository
UE User equipment
UMONC Usage monitoring control
WID Work item description

A recent study on usage monitoring control (UMONC) enhancements aims at deriving requirements and architecture enhancement for usage control for a subscriber group, e.g. members of a family or a company subscriber or a group of devices belonging to a subscriber that share the same usage allowance threshold.

Further, objectives regarding group communication system enablers for LTE (GCSE_LTE) are to specify system enablers' service requirements to the 3GPP system to support group communication over LTE for critical communications such as Public Safety, to define architectural requirements, and further, to develop GCSE_LTE solutions based on the service objectives and architectural requirements. The group communication may consist of various media. Examples of media comprise conversational type communication (voice, video) or streaming (video) or data (messaging) or a combination of them.

Currently suggested solutions control usage monitoring by allocating an allowance (i.e., a quota allowed to be consumed before reporting the monitored usage/consumption and requesting a new value) to a given user/member of the group. The allowance is typically a fraction of the total allowance reserved for the whole group. A controlling entity (SPR/UDR or PCRF) allocates the allowance to a monitoring/reporting entity, e.g. PCEF or TDF. The PCEF or TDF reports the monitored usage/consumption to PCRF, gets a new user/member related allowance value from the PCRF and continues monitoring. Allowance is allocated separately and usage monitoring results are reported separately for each member of the group. Consequently, these proposed solutions have the following problems.

The use of a group allowance is not optimal, because allowance/quota may have been given to users/group members who do not consume the allowance/quota, but simultaneously there may be other members of the same group who need/could use the remaining allowance/quota of the group.

Further, message exchange between the controlling entity and the monitoring/reporting entity is not optimal, because message exchange is needed for controlling and reporting for every allowance/quota of every user/group member. The non-optimally abundant message exchange increases also the total processing load on the controlling and monitoring/reporting entities.

Finally, user group applications which support simultaneous sending from one group member to other active group members (as GCSE_LTE mentioned above), may report the usage of group allowance multiple times for a single session, because each group member may report the user specific usage through its PCEF and PCRF. Or more generally, the resource efficiency within such a session is non-optimal.

### SUMMARY OF THE INVENTION

The invention aims at overcoming the above drawbacks. For example, the invention aims at providing subscriber group related control in a communication system which solves the above problems and optimization needs on using group allowance, minimizes needed message exchanges and processing load and gains resource efficiency.

This is at least in part achieved by the methods and apparatuses as defined in the appended claims. The invention may be implemented also by a computer program product including a program for a processing device, which may comprise a computer-readable medium. The program comprises software code portions, and may be directly loadable into an internal memory of the processing device.

According to an exemplary embodiment of the invention, for each member of a subscriber group the same monitoring/reporting entity and the same controlling entity are determined without requiring extra signaling steps compared to current non-group PCRF selection procedures.

In the following the invention will be described by way of exemplary embodiments thereof with reference to the accompanying drawings.

### BRIEF DESCRIPTION OF THE DRAWINGS

FIG. 1 shows an architecture illustrating an environment and network entities in which examples of embodiments of the invention are implementable.

FIG. 2 shows a flowchart illustrating a process 1 according to an exemplary embodiment of the invention.

FIG. 3 shows a flowchart illustrating a process 2 according to an exemplary embodiment of the invention.

FIG. 4 shows a signaling diagram illustrating a signaling scenario according to an implementation example of the invention.

FIG. 5 shows a schematic block diagram illustrating a configuration of a control unit in which examples of embodiments of the invention are implementable.

### DESCRIPTION OF THE EXEMPLARY EMBODIMENTS

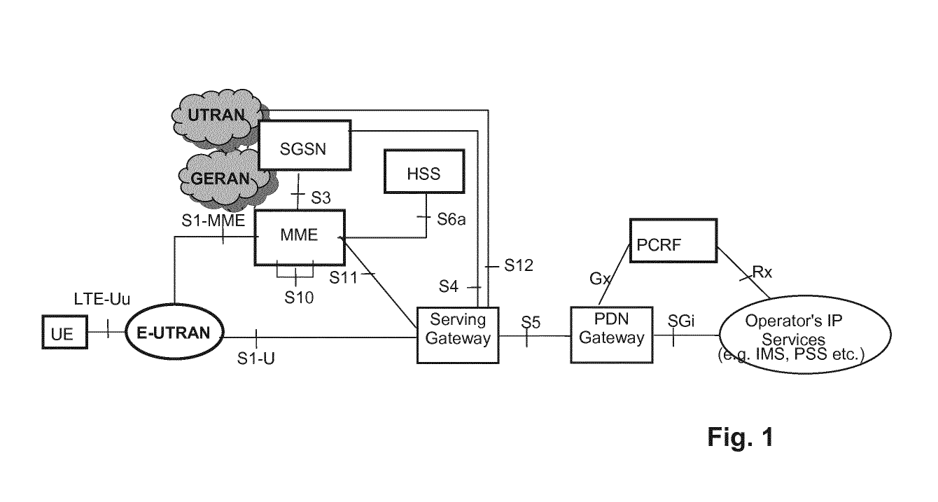

FIG. 1 shows an architecture illustrating an environment and network entities in which examples of embodiments of the invention are implementable.

As shown in FIG. 1, a UE attaches to an MME via an E-UTRAN through interfaces LTE-Uu and S1-MME. The MME has access to an HSS through an interface S6a and to a PDN gateway via a serving gateway through interfaces S11 and S5. The PDN gateway has access to a PCRF through an interface Gx. The PCRF has access to a UDR/SPR (not shown in FIG. 1) through an interface Sp/Ud.

FIG. 1 further shows an SGSN connected to the MME and the serving gateway through interfaces S3 and S4, an interface S1-U between the E-UTRAN and the serving gateway, an interface S1-MME between the E-UTRAN and the MME, access network clouds UTRAN and GERAN, an interface S10 between MMEs, an interface S12 between the UTRAN and the serving gateway, and “operator's IP services” connected to the PDN gateway through an interface SGi and to the PCRF through an interface Rx.

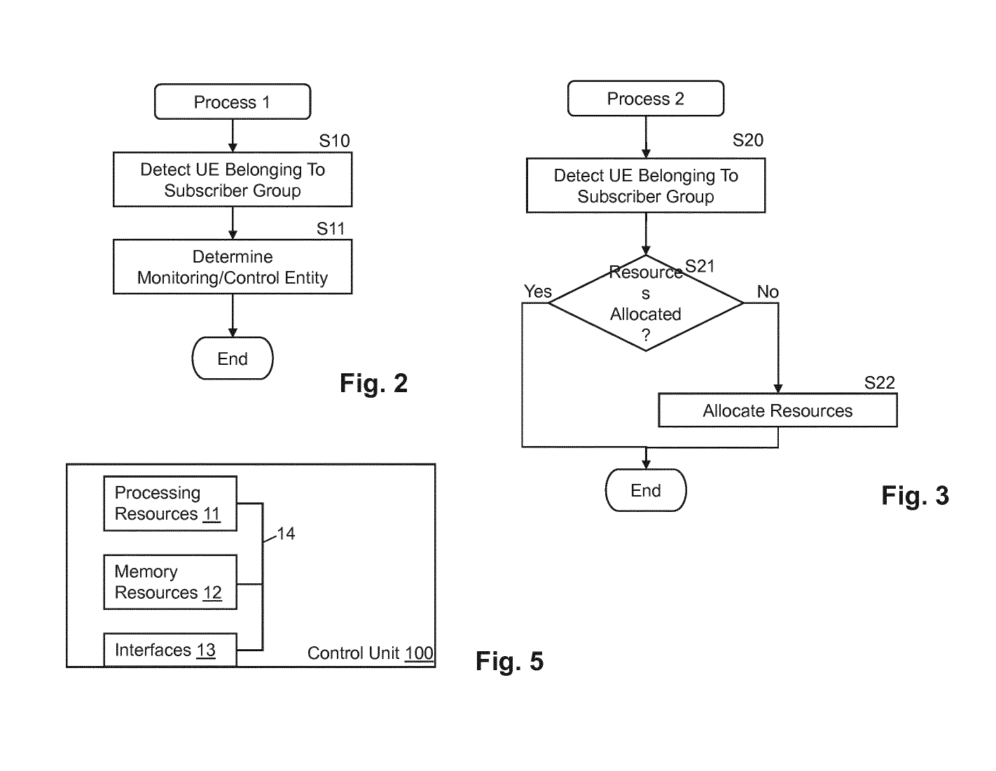

FIG. 2 shows a flowchart illustrating a process 1 according to an exemplary embodiment of the invention. The process 1 may be executed by an apparatus of a communication network, e.g. the HSS/UDR or the PDN gateway (P-GW) illustrated and/or described above.

In step S10, it is detected that a user equipment (UE) attaching to the communication network belongs to a subscriber group.

In step S11, in case step S10 is carried out by the HSS/UDR, a monitoring entity to monitor network resource usage for the user equipment is determined. The monitoring entity may comprise the P-GW acting as PCEF. In case step S10 is carried out by the P-GW, a control entity to control the monitoring for the user equipment is determined. The control entity may comprise the PCRF. For each user equipment belonging to the subscriber group the same monitoring entity and the same control entity are determined.

According to an exemplary embodiment of the invention, in step S10 it is further detected if the user equipment is the first user equipment of the subscriber group to attach to the communication network. For the event that the user equipment is the first user equipment, in step S11 the monitoring entity and/or the control entity for the user equipment is selected out of a plurality of monitoring entities and/or control entities. Alternatively or in addition, the monitoring entity and/or the control entity for the user equipment are selected based on an identifier of the subscriber group.

For the event that the user equipment is not the first user equipment of the subscriber group to attach to the communication network (i.e. if the monitoring entity and/or the control entity have been selected for the subscriber group the user equipment belongs to), in step S11, the monitoring entity and/or the control entity already selected for the subscriber group is determined for the user equipment.

According to an exemplary embodiment of the invention, in step S10, when it is further detected that another user equipment which is attached to the communication network has joined the subscriber group, in step 11, a handover of the user equipment to the monitoring entity and/or the control entity already selected for the subscriber group is caused.

With the above process 1, all active group members (e.g. user equipments of the subscriber group) use the same gateway (e.g. P-GW). A gateway/P-GW selection procedure is applied in such a way that a user/group member attaching the communication network is forced (by HSS/UDR) to use a certain gateway already selected for the identified group (the identified subscriber group), e.g. upon the activation of the first group member or when establishing the group in a subscription database (e.g. the HSS/UDR). The HSS/UDR may e.g. indicate/identify the P-GW to be used to a selecting entity (e.g. MME). If a member is already attached and has been allocated a different gateway, when joining the group, the gateway/P-GW selection procedure is applied in such a way that it forces a handover from the current gateway to the gateway allocated to the group. The HSS/UDR may e.g. indicate/identify the new to-be-used P-GW within an Insert Subscriber data message to the selecting entity (e.g. MME).

The gateway/P-GW selects the same PCRF for all members of a given group. According to an exemplary embodiment of the invention, the HSS/UDR sends group identification information (e.g. a group ID) to the selecting entity (e.g. MME), which sends the identification information further to the selected gateway/P-GW, which sends the information further to a DRA, which may use the group identity information to check whether a PCRF has already been allocated to the group. In other words, the control entity for the user equipment is selected based on an identifier of the subscriber group, which is sent from the HSS/UDR to the selecting entity, and from the selecting entity to the gateway/P-GW which may send the identifier to the DRA for determining the PCRF for the user equipment.

This enables usage monitoring and user group applications, as will be described in more detail below.

Usage monitoring may be performed per group allowance/quota instead of allowance per user/group member. In other words, according to an exemplary embodiment of the invention, the above-described gateway/P-GW (monitoring entity) monitors usage of network resources allocated for the subscriber group, for all user equipments of the subscriber group, which are attached to the communication network.

FIG. 3 shows a flowchart illustrating a process 2 according to an exemplary embodiment of the invention.

The process 2 may be executed by an apparatus of a communication network, e.g. the PCRF (control entity, PCEF) illustrated and described above.

In step S20, it is detected that a user equipment establishing a session with the communication network belongs to a subscriber group.

In step S21, it is checked whether or not network resources have been allocated for the subscriber group. In case the network resources have been allocated, process 2 ends.

Otherwise, in case the network resources have not been allocated, in step S22, the network resources for the subscriber group are allocated.

According to an exemplary embodiment of the invention, in step S20, the PCRF recognizes that a user (UE) establishing a session belongs to a (monitoring) group e.g. when accessing user data/profile from SPR/UDR. The invention is not limited thereto, and it is possible to get the information from the gateway/PCEF e.g. in the format of a group ID. In step S21, by maintaining status information per user group, the PCRF knows whether there is already at least one active user session in a given group, and whether also allowance/quota has been allocated for the group.

When a user (UE)/member of a given group activates a session, and if allowance/quota has not been allocated for the group (e.g. because there are no other active sessions going on in this group) (no in step S21), in step S22 the PCRF allocates a group allowance/quota for the group. The group is identified e.g. with a group ID in a message sent to the gateway/PCEF.

When a user (UE)/member of a given group activates a session, and if allowance/quota has already been allocated for the group (e.g. because there is at least one other active session going on in this group) (yes in step S21), the PCRF does not allocate any allowance/quota.

As mentioned above, the gateway/PCEF monitors all active members of a given group, aggregates the usage of the members and reports the aggregated usage to the PCRF when an appropriate trigger is met, e.g. the allocated allowance is used up. The PCRF may then apply PCC rules accordingly and/or send a new group allowance/quota to the PCEF.

User group applications which support simultaneous sending from one group member to other active group members (as GCSE_LTE mentioned above) may use the same user/traffic plane resources in the network when sending session traffic to active listeners/receivers.

Usage monitoring and user group applications described above can be applied separately or together. The common basic issue for them is that the group members are first forced to use the same gateway/P-GW.

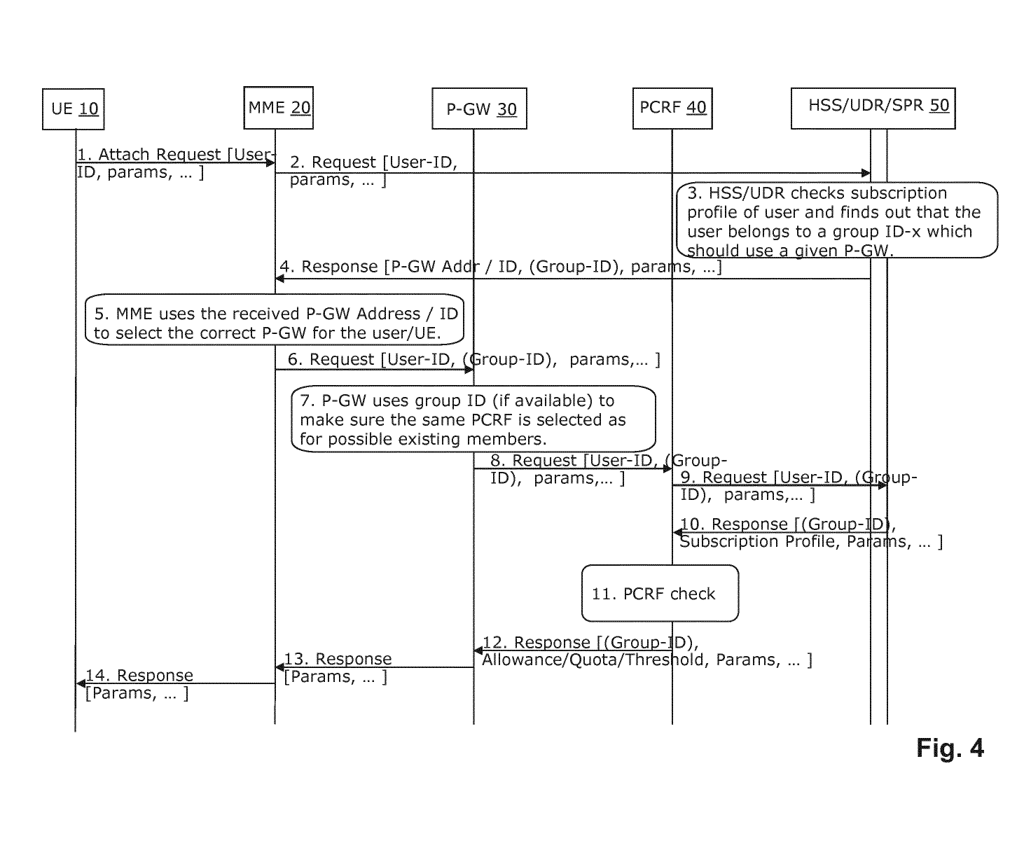

FIG. 4 illustrates an implementation example of the invention, of applying usage monitoring. Referring to FIG. 4, a basic case is described with a simplified signaling diagram, wherein a user/UE 10, belonging to a (monitoring) group, attaches the communication network and usage monitoring is started, i.e. there were no active group members with group based usage monitoring going on.

In step 1, the UE 10 attaches to the communication network. The UE sends an attach request to an MME 20, including e.g. a user-ID, parameters, etc.

In step 2, the MME 20 sends a request (Update Location Request) to a subscriber database HSS/UDR 50. The requests includes the user-ID, parameters, etc. The entity 50 is shown as comprising HSS, UDR and SPR, while separate entities may be provided for the HSS and the UDR, or the UDR and the SPR.

In step 3, the HSS/UDR 50 checks a subscription profile of the user and finds out that the user belongs to a group ID-x which should use a given P-GW 30.

In step 4, the HSS/UDR 50 sends a response message to the MME 20. The response message includes an address or identity of the P-GW 30 that should be used for/by the group members and parameters. The response message may include group identity information, e.g. a group-ID.

In step 5, the MME 20 uses the received P-GW Address/ID to select the correct P-GW 30 for the user/UE 10.

In step 6, the MME 20 sends a request (Create Session request) to the selected gateway/P-GW 30. The request includes the user-ID and parameters, and may include the group-ID.

In step 7, the P-GW 30 uses the group-ID (if available) to make sure the same PCRF 40 is selected as for possible existing members, by sending the group-ID in a request message to a DRA (not shown in FIG. 4) which may use the group identity information (group-ID) to check whether a PCRF has already been allocated to the group. The invention is not limited to selecting the PCRF based on a group-ID, and other means, replacing step 7 in FIG. 4, may be used for selecting the same PCRF for the group members. For example, the same PCRF may be selected based on the user-ID in a similar way as the same P-GW is selected.

In step 8, the P-GW 30 sends a request (CC-Request) to the PCRF 40. Among the user-ID and other parameters, the message may contain group identification information (e.g. group-ID), if available, e.g. received from the MME 20.

In step 9, the PCRF 40 sends a request to the subscription database (UDR/SPR) 50 to get the subscription profile and possibly other related parameters for the UE 10. The request may contain the user-ID or the group-ID or both.

In step 10, the UDR/SPR 50 sends a response message to the PCRF 40, which may contain user and group related subscription profiles/parameters. The response message in step 10 may contain the group-ID parameter to indicate that the profile (or one of the profiles) or parameters are related to a given group. The group-ID parameter is useful or may be needed here especially if the request in step 9 does not contain the group-ID.

In step 11, the PCRF 40 checks the subscription profile(s) and/or parameters and finds out that the user belongs to a group ID-x which shall be usage-monitored and may have a certain allowance/quota. The PCRF 40 also checks and finds out that there are no other active members in this group at the moment and decides to allocate allowance/quota/threshold for the group.

In step 12, the PCRF 40 sends a response message to the P-GW 30. Among possible other parameters, the response message contains the allowance/quota/threshold to be used for usage monitoring and reporting for the group. The response message in step 12 may contain the group-ID parameter to indicate that the allowance/quota/threshold and/or some other parameters are related to a given group. The group-ID parameter is useful or may be needed here especially if the request in step 8 does not contain the group-ID.

In step 13, the P-GW 30 sends a response message to the MME 20, acknowledging the request sent in step 6.

Finally, in step 14, the MME 20 sends a response message to the UE 10, acknowledging the request sent in step 1.

As described above, the HSS/UDR 50 applies a logic in the gateway (P-GW) selection procedure to force the members of a given group to use the same gateway/P-GW 30. A way to detect the members or active members of a group is to provide a group-ID, possibly with a separate activity indication, within the user profile of each group member.

Further, the PCRF 40 and the PCEF/gateway/P-GW 30 handle the allowances/quotas/thresholds per group, instead of per user/group member.

Now reference is made to FIG. 5 for illustrating a simplified block diagram of an electronic device that is suitable for use in practicing the exemplary embodiments of this invention.

FIG. 5 shows a control unit 100 which may be part of and/or used by the HSS/UDR/SPR 50. Similarly, a control unit such as the control unit 100 may be part of and/or used by the P-GW 30 and the PCRF 40.

The control unit 100 comprises processing resources 11, memory resources 12 and interfaces 13, which are connected via a link 14. The memory resources 12 may store a program.

Throughout this application, the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The program stored by the memory resources 12 is assumed to include program instructions that, when executed by the associated processing resources 11, enable the electronic device to operate in accordance with the exemplary embodiments of this invention, as detailed above.

In general, the exemplary embodiments of this invention may be implemented by computer software stored in the memory resources 12 and executable by the processing resources 11, or by hardware, or by a combination of software and/or firmware and hardware.

The memory resources 12 may be of any type suitable to the local technical environment and may be implemented using any suitable data storage technology, such as semiconductor-based memory devices, magnetic memory devices and systems, optical memory devices and systems, fixed memory and removable memory. The processing resources 11 may be of any type suitable to the local technical environment, and may include one or more of general purpose computers, special purpose computers, microprocessors, digital signal processors (DSPs) and processors based on a multi-core processor architecture, as non-limiting examples.

According to an aspect of the invention, an apparatus of a communication network is provided. The apparatus may comprise and/or make use of the control unit 100 shown in FIG. 5. The apparatus may comprise the HSS/UDR 50 and the P-GW 30 shown in FIG. 4.

The apparatus comprises means for detecting that a user equipment attaching to the communication network belongs to a subscriber group, and means for determining a monitoring entity to monitor network resource usage for the user equipment and/or a control entity to control the monitoring for the user equipment, wherein for each user equipment belonging to the subscriber group the same monitoring entity and the same control entity are determined.

According to an exemplary embodiment of the invention, the means for detecting detects that the user equipment is the first user equipment of the subscriber group to attach to the communication network, and the means for determining selects the monitoring entity and/or the control entity for the user equipment out of a plurality of monitoring entities and/or control entities.

According to an exemplary embodiment of the invention, the means for determining selects the monitoring entity and/or the control entity for the user equipment based on an identifier of the subscriber group.

According to an exemplary embodiment of the invention, the means for detecting detects that the monitoring entity and/or the control entity have been selected for the subscriber group the user equipment belongs to, and the means for determining determines, for the user equipment, the monitoring entity and/or the control entity selected for the subscriber group.

According to an exemplary embodiment of the invention, the means for detecting detects that another user equipment which is attached to the communication network has joined the subscriber group, and the means for determining causes a handover of the user equipment to the monitoring entity and/or the control entity selected for the subscriber group.

According to an exemplary embodiment of the invention, the apparatus comprises means for monitoring usage of network resources allocated for the subscriber group, for all user equipments of the subscriber group, which are attached to the communication network.

The detecting, determining and monitoring means may be implemented by the processing resources 11, memory resources 12 and interfaces 13 of the control unit 100.

According to another aspect of the invention, an apparatus of a communication network is provided. The apparatus may comprise and/or make use of the control unit 100 shown in FIG. 5. The apparatus may comprise the PCRF 40 shown in FIG. 4.

The apparatus comprises means for detecting that a user equipment establishing a session with the communication network belongs to a subscriber group, means for checking whether or not network resources have been allocated for the subscriber group, and means for, in case the network resources have been allocated, not allocating any other network resources for the user equipment, and in case the network resources have not been allocated, allocating the network resources for the subscriber group.

The means for detecting, checking and allocating may be implemented by the processing resources 11, memory resources 12 and interfaces 13 of the control unit 100.

It is to be understood that the above description is illustrative of the invention and is not to be construed as limiting the invention. Various modifications and applications may occur to those skilled in the art without departing from the true spirit and scope of the invention as defined by the appended claims.

1. A method for use by an apparatus of a communication network, the method comprising:
detecting that a user equipment attaching to the communication network belongs to a subscriber group; and
determining a monitoring entity to monitor network resource usage for the user equipment and/or a control entity to control the monitoring for the user equipment, wherein for each user equipment belonging to the subscriber group the same monitoring entity and the same control entity are determined.

2. The method of claim 1, comprising:
detecting that the user equipment is the first user equipment of the subscriber group to attach to the communication network; and
selecting the monitoring entity and/or the control entity for the user equipment out of a plurality of monitoring entities and/or control entities.

3. The method of claim 1, comprising:
determining the monitoring entity and/or the control entity for the user equipment based on an identifier of the subscriber group.

4. The method of claim 1, comprising:
detecting that the monitoring entity and/or the control entity have been selected for the subscriber group the user equipment belongs to; and
determining, for the user equipment, the monitoring entity and/or the control entity selected for the subscriber group.

5. The method of claim 4, comprising:
detecting that another user equipment which is attached to the communication network has joined the subscriber group; and
causing a handover of the user equipment to the monitoring entity and/or the control entity selected for the subscriber group.

6. The method of claim 1, comprising:
monitoring usage of network resources allocated for the subscriber group, for all user equipments of the subscriber group, which are attached to the communication network.

7. A method for use by an apparatus of a communication network, the method comprising:
detecting that a user equipment establishing a session with the communication network belongs to a subscriber group;
checking whether or not network resources have been allocated for the subscriber group;
in case the network resources have been allocated, not allocating any other network resources for the user equipment, and
in case the network resources have not been allocated, allocating the network resources for the subscriber group.

8. A computer program product embodied on a non-transitory computer-readable medium, said product including a program for a processing device, comprising software code portions for performing the steps of claim 1 when the program is run on the processing device.

9. (canceled)

10. The computer program product according to claim 8, wherein the program is directly loadable into an internal memory of the processing device.

11. An apparatus of a communication network, the apparatus comprising processing resources and memory resources, which cause the apparatus to perform:
detecting that a user equipment attaching to the communication network belongs to a subscriber group; and
determining a monitoring entity to monitor network resource usage for the user equipment and/or a control entity to control the monitoring for the user equipment, wherein for each user equipment belonging to the subscriber group the same monitoring entity and the same control entity are determined.

12. The apparatus of claim 11, wherein the processing resources and memory resources cause the apparatus to perform:
detecting that the user equipment is the first user equipment of the subscriber group to attach to the communication network; and
selecting the monitoring entity and/or the control entity for the user equipment out of a plurality of monitoring entities and/or control entities.

13. The apparatus of claim 11 or 12, wherein the processing resources and memory resources cause the apparatus to perform:
determining the monitoring entity and/or the control entity for the user equipment based on an identifier of the subscriber group.

14. The apparatus of claim 11, wherein the processing resources and memory resources cause the apparatus to perform:
detecting that the monitoring entity and/or the control entity have been selected for the subscriber group the user equipment belongs to; and
determining, for the user equipment, the monitoring entity and/or the control entity selected for the subscriber group.

15. The apparatus of claim 14, wherein the processing resources and memory resources cause the apparatus to perform:
detecting that another user equipment which is attached to the communication network has joined the subscriber group; and
causing a handover of the user equipment to the monitoring entity and/or the control entity selected for the subscriber group.

16. The apparatus of claim 11, wherein the processing resources and memory resources cause the apparatus to perform:
monitoring usage of network resources allocated for the subscriber group, for all user equipments of the subscriber group, which are attached to the communication network.

17. An apparatus of a communication network, the apparatus comprising processing resources and memory resources, which cause the apparatus to perform:
detecting that a user equipment establishing a session with the communication network belongs to a subscriber group;
checking whether or not network resources have been allocated for the subscriber group;
in case the network resources have been allocated, not allocating any other network resources for the user equipment, and
in case the network resources have not been allocated, allocating the network resources for the subscriber group.
